(19) United States
(12) Patent Application Publication
(10) Pub. No.: US 2012/0148935 A1
(43) Pub. Date: Jun. 14, 2012

(54) MANUFACTURING METHOD OF MEMBRANE-ELECTRODE ASSEMBLY FOR POLYMER ELECTROLYTE MEMBRANE FUEL CELL

(75) Inventors: Hoon Hui Lee, Seoul (KR); Nak Hyun Kwon, Seoul (KR); Ji Seok Hwang, Yongin (KR)

(73) Assignees: KIA MOTORS CORPORATION, Seoul (KR); HYUNDAI MOTOR COMPANY, Seoul (KR)

(21) Appl. No.: 13/152,442

(22) Filed: Jun. 3, 2011

(30) Foreign Application Priority Data
Dec. 8, 2010 (KR) 10-2010-0124587

(51) Int. Cl. H01M 8/10; B32B 38/00; H01M 8/00

(52) U.S. Cl. 429/481; 429/535; 156/182

(57) ABSTRACT

The present invention provides a method of fabricating a membrane-electrode assembly for a polymer electrolyte membrane fuel cell, and a membrane-electrode assembly and a polymer electrolyte membrane fuel cell formed thereby. In the method, a 3-layered membrane-electrode assembly is formed in which a catalyst electrode layer is disposed on both surfaces of a polymer electrolyte membrane. A sub-gasket having an opening therein and having a primer layer formed on one surface thereof is formed, and is attached on both surfaces of the 3-layered membrane-electrode assembly such that the surface of the sub-gasket having the primer layer formed thereon faces the outside (is exposed) and the catalyst electrode layer is exposed through the opening. A 7-layered membrane-electrode assembly is then formed by stacking a gas diffusion layer on the primer layer exposed on both surfaces of the 5-layered membrane-electrode assembly to cover the catalyst electrode layer, and then performing a hot-pressing process to attach the sub-gasket and the gas diffusion layer to each other via the primer layer.

### CROSS-REFERENCE TO RELATED APPLICATION

This application claims under 35 U.S.C. §119(a) the benefit of Korean Patent Application No. 10-2010-0124587 filed Dec. 8, 2010, the entire contents of which are incorporated herein by reference.

### BACKGROUND

(a) Technical Field

The present invention relates to a method of manufacturing a membrane-electrode assembly for a polymer electrolyte membrane fuel cell. Particularly, it relates to a method for fabricating a 7-layered membrane-electrode assembly in which gas diffusion layers are attached to both surfaces of a 5-layered membrane-electrode assembly regardless of whether a direct coating method or a decal method for forming catalyst electrode layers on both surfaces of a polymer electrolyte membrane is used to fabricate a 3-layered membrane-electrode assembly.

### (b) Background Art

A fuel cell is a power generation device that converts chemical energy of fuel into electrical energy by performing electrochemical reactions in a stack without transforming the chemical energy into heat by combustion. Fuel cells can be applied to the electric power supply of small-sized electrical and electronic devices, for example portable devices, as well as industrial and household appliances and vehicles.

Polymer Electrolyte Membrane Fuel Cells (PEMFCs, also known as Proton Exchange Membrane Fuel Cells), which have the highest power density among fuel cells, are being extensively studied as a power supply source for driving vehicles. PEMFCs advantageously have a quick startup time and a power transformation reaction time due to a low operating temperature.

Such a polymer electrolyte membrane fuel cell includes a membrane electrode assembly (MEA), a gas diffusion layer (GDL), a gasket, a sealing/coupling member, and a bipolar plate. The MEA includes a polymer electrolyte membrane through which hydrogen ions are transported, and an electrode/catalyst layer, in which an electrochemical reaction takes place, is disposed on each of both sides of the polymer electrolyte membrane. The GDL functions to uniformly diffuse reactant gases and transmit generated electricity. The gasket functions to provide an appropriate airtightness to reactant gases and coolant. The sealing/coupling member functions to provide an appropriate bonding pressure. The bipolar plate functions to support the MEA and GDL, collect and transmit generated electricity, transmit reactant gases, transmit and remove reaction products, and transmit coolant to remove reaction heat, etc.

When a fuel cell stack is fabricated using the unit cells as configured above, a combination of the membrane-electrode assembly (MEA) and the gas diffusion layer (GDL), which are main components, are disposed at the innermost portion of the unit cell. The membrane-electrode assembly includes catalyst electrode layers, i.e., cathode and anode with a catalyst coated on both surfaces of the polymer electrolyte membrane, which allows hydrogen and oxygen to react with each other. In addition, gas diffusion layers and gaskets are stacked on the outside of the cathode and the anode.

The bipolar plate is located at the outside of the gas diffusion layer to provide a flow field that supplies reaction gases (hydrogen as fuel and oxygen or air as oxidant) and allows the flow of cooling water.

A plurality of unit cells as configured above are stacked, and then end plates are coupled to the outermost portions of the stacked unit cells to support a current collector, an insulation plate, and the stacked cells, thereby forming a fuel cell stack.

The fuel cell stack may be mass-produced by manufacturing a 7-layered membrane-electrode assembly with a sub-gasket and a gas diffusion layer attached to each other, and allowing the 7-layered membrane-electrode assembly to undergo an automated process for assembling it with bipolar plates and end plates.

In particular, a 3-layered membrane-electrode assembly may be formed in which catalyst electrode layers are fixed on both surfaces of a polymer electrolyte membrane, and then a 5-layered membrane-electrode assembly may be formed by attaching sub-gaskets on both surfaces of the electrolyte membrane such that an active area (i.e., catalyst electrode layer) of the membrane-electrode assembly is exposed.

After the 5-layered membrane-electrode assembly is formed, gas diffusion layers are attached to the active area of the membrane-electrode assembly that is exposed through an opening of the sub-gasket to thereby form a 7-layered membrane-electrode assembly. In particular, the gas diffusion layers are attached to the catalyst electrode layers on both surfaces of the membrane-electrode assembly, for example, through a hot-pressing method. Thereafter, the 7-layered membrane-electrode assembly undergoes a stack fabrication process in which an automated stacking method is applied using vacuum absorption.

FIG. 1 is a diagram illustrating a method of fabricating a typical membrane-electrode assembly. As shown in FIG. 1, direct coating and decal methods may be used to fabricate a 5-layered membrane-electrode assembly.

The direct coating method includes forming a catalyst slurry (electrode slurry), forming a catalyst electrode layer 2 by directly coating the catalyst slurry 2a on both surfaces of an electrolyte membrane 1 and then drying to form a 3 layered membrane-electrode assembly (MEA)₃, and then attaching a sub-gasket 4 on both surfaces of the 3-layered membrane-electrode assembly 3 using a hot-pressing or roll-laminating method to form a 5-layered membrane-electrode assembly 5.

On the other hand, the decal method includes forming a catalyst layer 2 by coating catalyst slurry 2a on the surface of a release film 9 and drying it, stacking the release film with the catalyst electrode layer 2 on both surfaces of an electrolyte membrane 1, respectively, transcribing the catalyst electrode layer 2 on the both surfaces of the electrolyte membrane 1 by a hot-pressing method, removing the release film 9 to form a 3-layered membrane-electrode assembly (MEA) 3, and attaching a sub gasket 4 on both surfaces of the 3-layered membrane-electrode assembly 3 using a hot-pressing or roll-laminating method to form a 5-layered membrane-electrode assembly 5.

Thereafter, in order to fabricate a 7-layered membrane-electrode assembly 7, a gas diffusion layer 6 is attached to both surfaces of the 5-layered membrane-electrode assembly 5. In the case of the 5-layered membrane-electrode assembly fabricated by the direct coating method, there is no limitation in forming the 7-layered membrane-electrode assembly 7 because the surfaces of the gas diffusion layer 6 and the catalyst electrode layer 2 are attached to each other during the hot-pressing.

In other words, since the surface of the catalyst electrode layer 2 formed by the direct-coating process is uneven, the surface of the gas diffusion layer 6 and the surface of the catalyst electrode layer 2 may be fixedly attached to each other to form the 7-layered membrane-electrode assembly 7.

However, in the case of the 5-layered membrane-electrode assembly 5 fabricated by the decal method, since the surface of the catalyst electrode layer 2 is smooth, it is difficult to attach and fix the surface of the gas diffusion layer 6 to the surface of the catalyst electrode layer 2 through only hot-pressing.

Thus, the decal method has a limitation in that it is difficult to form the 7-layered membrane-electrode assembly 7 because the adhesive strength between the surface of the catalyst electrode layer 7 and the surface of the sub-gasket 4 is weak. Thus, the sub-gasket 4 must be manually stacked on the 5-layered membrane-electrode assembly 5 to manufacture a stack. Accordingly, it is difficult to apply an automated process to the stack fabrication. This becomes an obstacle to mass production of the stack.

The above information disclosed in this Background section is only for enhancement of understanding of the background of the invention and therefore it may contain information that does not form the prior art that is already known in this country to a person of ordinary skill in the art.

### SUMMARY OF THE DISCLOSURE

The present invention provides a method for fabricating a 7-layered membrane-electrode assembly in which gas diffusion layers are attached to both surfaces of a 5-layered membrane-electrode assembly, and in particular, regardless of whether a direct coating method or a decal method is used to form catalyst electrode layers on both surfaces of a polymer electrolyte membrane (i.e. in forming the 3 layer MEA).

In one aspect, the present invention provides a method of fabricating a membrane-electrode assembly for a polymer electrolyte membrane fuel cell, the method including: forming a 3-layered membrane-electrode assembly in which a catalyst electrode layer is formed at both surfaces of a polymer electrolyte membrane; forming a sub-gasket having a primer layer formed on one surface thereof to which a gas diffusion layer is attached; forming a 5-layered membrane-electrode assembly by attaching the sub-gasket on both surfaces of the 3-layered membrane-electrode assembly such that the surface of the sub-gasket with the primer layer formed on faces the outside while exposing the catalyst electrode layer through an opening therein; and forming a 7-layered membrane-electrode assembly by stacking the gas diffusion layer on the primer layer of both surfaces of the 5-layered membrane-electrode assembly to cover the catalyst electrode layer, and then performing a hot-pressing process to attach the sub-gasket and the gas diffusion layer to each other via the primer layer.

In a preferred embodiment, the surface of an edge portion of the opening of the sub-gasket may be attached to an edge portion of the gas diffusion layer by the primer layer.

In another preferred embodiment, the primer layer may be formed by coating a liquid primer along the surface of the edge portion of the opening of the sub-gasket and subsequent drying of the same.

In still another preferred embodiment, the primer layer may be formed by coating a liquid primer on the whole of one surface of the sub-gasket and subsequent drying of the same.

In another aspect, the present invention provides a membrane-electrode assembly for a polymer electrolyte membrane fuel cell, including a 7-layered membrane-electrode assembly being formed by: attaching a sub-gasket having an opening therein to both surfaces of a membrane-electrode assembly, the membrane-electrode assembly comprising a polymer electrolyte membrane with a catalyst electrode layer formed on both surfaces thereof such that the catalyst electrode layer is exposed through the opening in the sub-gasket, and stacking a gas diffusion layer to cover the catalyst electrode layer exposed through the opening in the sub-gasket, wherein the gas diffusion layers is attached to the sub-gasket by a primer layer interposed therebetween.

In a preferred embodiment, the surface of an edge portion of the gas diffusion layer may be attached to an edge portion of the opening 4a of the sub-gasket by the primer layer.

Other aspects and preferred embodiments of the invention are discussed infra.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The above and other features of the invention are discussed infra.

### BRIEF DESCRIPTION OF THE DRAWINGS

The above and other features of the present invention will now be described in detail with reference to certain exemplary embodiments thereof illustrated the accompanying drawings which are given hereinbelow by way of illustration only, and thus are not limitative of the present invention, and wherein:

FIG. 1 is a diagram illustrating a method for fabricating a typical membrane-electrode assembly;

FIG. 2 is a diagram illustrating a primer coating process performed on a sub-gasket to fabricate a membrane-electrode assembly according to an embodiment of the present invention; and

FIG. 3 is a diagram illustrating a process for the formation of a 7 layer membrane-electrode assembly according to an embodiment of the present invention, after the 3-layered membrane-electrode assembly is fabricated.

Reference numerals set forth in the Drawings includes reference to the following elements as further discussed below:
1: polymer electrolyte membrane
2: catalyst electrode layer
3: 3-layered membrane-electrode assembly
4: sub-gasket
4a: opening
5: 5-layered membrane-electrode assembly
6: gas diffusion layer
7: 7-layered membrane-electrode assembly
10: primer layer

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter reference will now be made in detail to various embodiments of the present invention, examples of which are illustrated in the accompanying drawings and described below. While the invention will be described in conjunction with exemplary embodiments, it will be understood that present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims.

Hereinafter, exemplary embodiments of the present invention will be described in detail with reference to the accompanying drawings.

The present invention relates to a method of fabricating a membrane-electrode assembly for a polymer electrolyte fuel cell. In particular, it relates to an improved method for fabricating a 7-layered membrane-electrode assembly in which catalyst electrode layers, sub-gaskets, and gas diffusion layers are attached to both surfaces of an electrolyte membrane.

Using the method according to an embodiment of the present invention to fabricate the 7-layered membrane-electrode assembly, an automated process may be applied to mass-produce a fuel cell stack. In order to mass-produce the fuel cell stack, the 7-layered membrane-electrode assembly may undergo a stack fabrication process, in which an automated stacking method using vacuum absorption is applied, to be fabricated together with bipolar plates and end plates.

According to an embodiment of the present invention, a sub-gasket that is processed with primer may be used. In particular, a process of coating primer on the surface of the sub-gasket may be further performed before a 5-layered membrane-electrode assembly (i.e., a structure in which catalyst electrode layers and sub-gaskets are attached to both surfaces of an electrolyte membrane) is fabricated.

The sub-gaskets of the 5-layered membrane-electrode assembly and the 7-layered membrane-electrode assembly may serve to maintain the dimension of the electrolyte membrane that typically varies according to temperature and humidity, and may allow a sealing load to be applied without damage to the electrolyte membrane upon coupling of the stack. The sub-gaskets may further prevent a local concentration of stress on the electrolyte membrane, which may be generated due to coupling pressure, and in some embodiments, the sub-gaskets may cover the catalyst electrode layer to define an active area of the membrane-electrode assembly.

According to various embodiments, the primer may be a material that is usually used to enhance adhesive strength between the surface of a target and an adhesive when two objects are attached to each other using the adhesive, and, in the present invention, the primer may serve to provide adhesive strength to the gas diffusion layers and/or the sub-gaskets of the 5-layered membrane-electrode assembly.

In particular, according to various embodiments, the gas diffusion layer may be directly attached to the surface of an edge portion of the opening of the sub-gasket in order to form the 7-layered membrane-electrode assembly. This attachment can be provided using primer, for example, as described below.

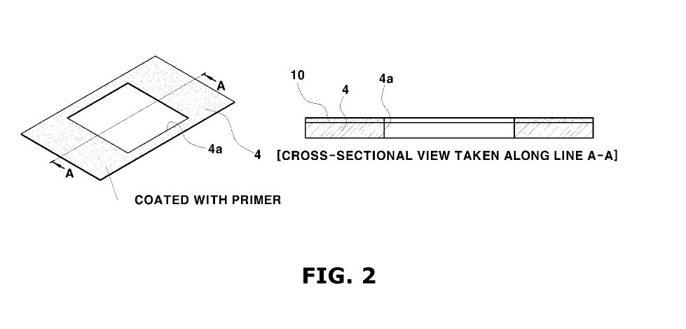

FIG. 2 is a diagram illustrating a primer coating process performed on a sub-gasket to fabricate a membrane-electrode assembly according to an embodiment of the present invention.

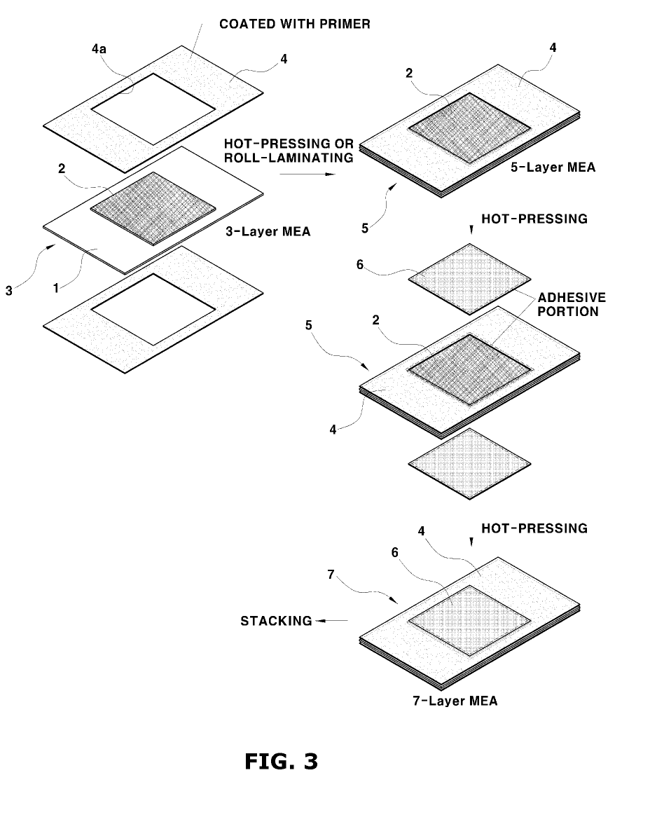

Referring to FIG. 2, a sub-gasket 4 may have an opening 4a configured to expose a catalyst electrode layer (active area) of a membrane-electrode assembly. A gas diffusion layer 6 (see FIG. 3) may be disposed on a 7-layered membrane-electrode assembly that is finally completed. In various embodiments, the gas diffusion layer 6 may be disposed so as to cover the catalyst electrode layer that is exposed through the opening 4a.

The gas diffusion layer 6 may be attached to both surfaces of a 5-layered membrane-electrode assembly to cover the opening 4a of the sub-gasket (e.g. as shown in FIG. 3). In various embodiments, all or portions of the surface of the sub-gasket 4 that form an outer surface of the 5-layered membrane-electrode assembly may be coated with primer.

As shown in FIG. 2, a primer layer 10 may be coated on a surface of the sub-gasket 4 (i.e. the “outer surface”). The primer layer 10 can be coated over the entire outer surface of the sub-gasket 4 or only portion(s) of the outer surface can be coated. The primer layer 10 can have any suitable thickness relative to the thickness of the sub-gasket 4. For example, the primer layer 10 can be provided to have a thickness of about several to about several tens of nanometers, with the sub-gasket 4 having a thickness of, for example, about 25 μm. The gas diffusion layer 6 may, in turn, be attached to the outer surface of the sub-gasket 4 on which the primer layer 10 is coated. The gas diffusion layer 6, thus, may be attached to the surface of the sub-gasket 4 by adhesive strength of the primer layer 10.

In this case, the gas diffusion layer 6 is fixed on the sub-gasket 4 such that the catalyst electrode layer 2 is exposed by the opening 4a. Thus, in some embodiments, the portion of the sub-gasket 4 to which the gas diffusion layer 6 is actually attached may be the surface of an edge portion surrounding the opening 4a. As such, a portion of the gas diffusion layer 6 contacting the sub-gasket 4 may also be the surface of an edge portion of the gas diffusion layer 6.

Thus, in this embodiment, at least that portion of the surface of the sub-gasket 4 around the opening 4a is coated with primer. In embodiments wherein primer coating is performed on only the surface of the sub-gasket 4 around the opening 4a to which the gas diffusion layer is actually attached, the primer coating process may be difficult or may include an additional process because it the coating is selectively performed. Accordingly, in some embodiments, the primer coating may be performed on the entire surface of the sub-gasket 4 to which the gas diffusion layer 6 is attached (i.e. extending to portions of the sub-gasket 4 beyond the portion surrounding the opening 4a).

According to various embodiments, the primer coating can be provided by coating a liquid primer on one surface of the sub-gasket 4 and drying the liquid layer to form a solid/solidified primer layer 10 on the surface of the sub-gasket 4.

After the sub-gasket 4 is coated with primer, the sub-gasket 4 may be used to fabricate a 5-layered membrane-electrode assembly. Thereafter, the gas diffusion layer may be directly attached to the primer layer 10 of the sub-gasket 4 to form a 7-layered membrane-electrode assembly.

In the process of fabricating the 7-layered membrane-electrode assembly, hot pressing can be carried out wherein the gas diffusion layer 6 is attached to the primer layer 10 due to adhesion generated during the hot-pressing.

For example, according to various embodiments, the 5-layered membrane-electrode assembly may first be fabricated by coating the sub-gasket 4 with a primer layer 10, followed by stacking the gas diffusion layer 6 on both surfaces of the 5-layered membrane-electrode assembly. Thereafter, hot-pressing may be performed such that an edge portion of the gas diffusion layer 6 attaches to an edge portion of the opening 4a of the sub-gasket 4 via the primer layer 10. Thus, the 7-layered membrane-electrode assembly having the attached gas diffusion layer 6 may be fabricated by the above processes.

In the fabrication of the 7-layered membrane-electrode assembly, the primer that is coated on the surface of the sub-gasket 4 to allow the sub-gasket 4 and the gas diffusion layer to be attached to each other during the hot-pressing may include any suitable primer materials including, but not limited to, acrylic resin such as alkyl acrylate, alkyl methacrylate, monomer containing hydroxyl group (e.g., hydroxy ethyl acrylate and hydroxylethyl methacrylate), glycidyl acrylate, and glycidyl methacrylate.

In some embodiments, the primer may further include additional materials commonly included in primer layers such as materials that further can assist in adhesion between the sub-gasket 4 and the gas diffusion layer 6. For example, in various embodiments, the primer may further include materials such as acrylamide, methacryl amide, alkyl methacryl amide, dialkyl methacryl amide, alkocy methacryl amide, methylol methacryl amide, and/or phenyl methacryl amide.

Hereinafter, a process for fabricating a 7-layered membrane-electrode assembly according to an embodiment of the present invention will be described in detail with reference to FIG. 3.

FIG. 3 illustrates a process for the fabrication of a 7 layer membrane-electrode assembly 7 (i.e., 3-layer MEA→5-layer MEA→7-layer MEA) after a 3-layered membrane-electrode assembly 3 has already been fabricated.

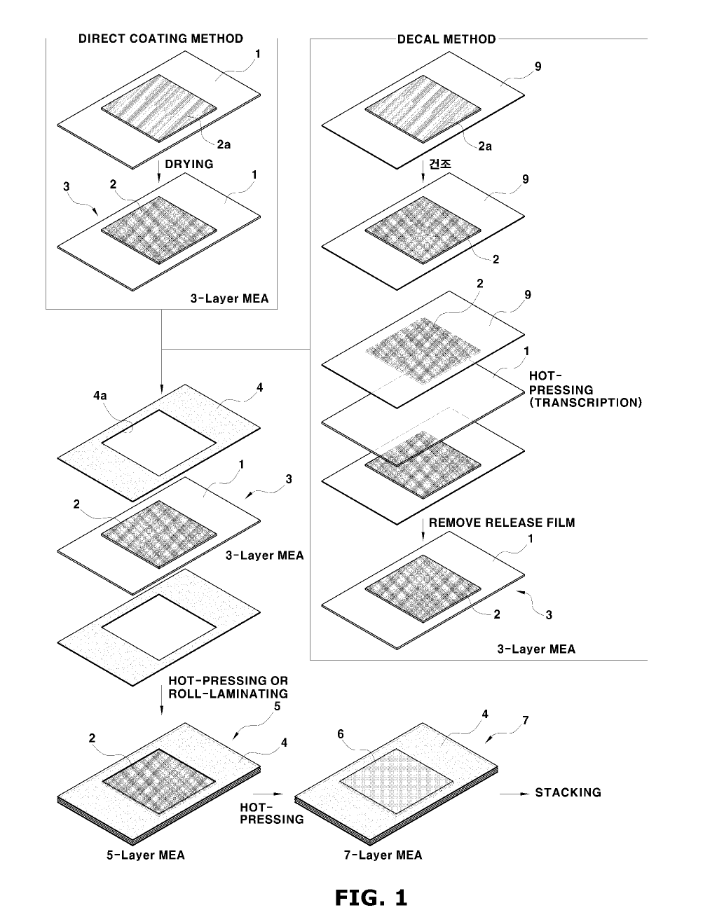

The process for fabricating the 3-layered membrane-electrode assembly 3 Is not particularly limited, and may include, for example, forming catalyst electrode layers 2 (cathode and anode) on both surface of a polymer electrolyte membrane 1 using a method similar to those described with reference to FIG. 1, and, thus, may be performed using a decal method or a direct coating method.

As shown in FIG. 3, after the 3-layered membrane-electrode assembly 3 is fabricated, sub-gaskets 4 may be attached to both surfaces of the membrane-electrode assembly 3. The sub-gaskets 4 are coated on their “outer surfaces” with primer and, as shown, the sub-gaskets 4 are attached to the surfaces of the membrane-electrode assembly 3 such that the primer-coated surfaces of the sub-gaskets 4 face the outside (i.e. away from the membrane-electrode assembly 3). In various embodiments, while and/or after the sub-gaskets 4 are being stacked, a hot-pressing or roll-laminating process may be performed to fix the sub-gaskets 4 and thereby form a 5-layered membrane-electrode assembly 5.

Next, gas diffusion layers 6 may be stacked to cover both surfaces (“outer surfaces”) of the 5-layered membrane-electrode assembly. In particular, the gas diffusion layers 6 are provided so as to cover openings 4a of the sub-gaskets 4 which have been coated with primer (i.e., having a primer layer 10). A hot-pressing process may then be performed to attach an edge portion of the gas diffusion layer 6 to an edge portion of the opening 4a of the sub-gasket 4 by adhesive strength of the primer layer 10. Thus, a 7-layered membrane-electrode assembly 7 having the attached gas diffusion layer 6 may be fabricated.

Thus, the 7-layered membrane-electrode assembly 7 may be formed by attaching a sub-gasket 4 to the both surfaces of the membrane-electrode assembly 3, wherein the membrane-electrode assembly 3 includes the polymer electrolyte membrane 1 with the catalyst electrode layers 2 formed at both surfaces thereof, wherein that the catalyst electrode layer 2 is exposed through the openings 4a in the sub-gaskets 4; and subsequently stacking the gas diffusion layers 6 on each side of thereof so as to cover the catalyst electrode layer 2 that is exposed through the openings 4a. In this case, the gas diffusion layers 6 may be attached to the sub-gasket 4 via a primer layer 10 interposed therebetween.

Thus, for example, an edge portion of the gas diffusion layer 6 may be attached to the surface of an edge portion of the opening 4a of the sub-gasket 4 via the primer layer 10.

The 7-layered membrane-electrode assembly may thus be fabricated by attaching the gas diffusion layer 6 to the sub-gasket 4 using primer. Further, when a stack is fabricated in a stack fabrication process to which an automated stacking method is applied using vacuum absorption, the stack can be mass-produced.

A method for fabricating a membrane-electrode assembly according to an embodiment of the present invention enables mass-production of a fuel cell stack by attaching a gas diffusion layer 6 to a sub-gasket 4 coated with primer after hot-pressing to form a 7-layered membrane-electrode assembly, and further allows the 7-layered membrane-electrode assembly to undergo an automated process.

The invention has been described in detail with reference to preferred embodiments thereof. However, it will be appreciated by those skilled in the art that changes may be made in these embodiments without departing from the principles and spirit of the invention, the scope of which is defined in the appended claims and their equivalents.

What is claimed is:

1. A method of fabricating a membrane-electrode assembly for a polymer electrolyte membrane fuel cell, the method comprising:
forming a 3-layered membrane-electrode assembly comprising a polymer electrolyte membrane and a catalyst electrode layer disposed on both surfaces of the polymer electrolyte membrane;
forming a sub-gasket having an opening therein, the sub-gasket having a primer layer coated on one surface thereof;
forming a 5-layered membrane-electrode assembly by attaching the sub-gasket on both surfaces of the 3-layered membrane-electrode assembly, whereby the surface of the sub-gasket having the primer layer coated thereon is exposed on each side of the 5-layered membrane-electrode assembly, and wherein at least a portion of the catalyst electrode layer is exposed through the opening in the sub-gasket; and
forming a 7-layered membrane-electrode assembly by stacking a gas diffusion layer on the primer layer exposed on each side of the 5-layered membrane-electrode assembly, whereby the gas diffusion layer is stacked to cover the exposed catalyst electrode layer, and performing hot-pressing to attach the sub-gasket and the gas diffusion layer to each other via the primer layer.

2. The method of claim 1, wherein a surface of an edge portion surrounding the opening of the sub-gasket is attached to an edge portion of the gas diffusion layer via the primer layer.

3. The method of claim 1, wherein the primer layer is formed by coating a liquid primer along a surface of an edge portion surrounding the opening of the sub-gasket, and subsequently drying the liquid primer.

4. The method of claim 1, wherein the primer layer is formed by coating a liquid primer on the entire surface of the sub-gasket, and subsequently drying the liquid primer.

5. A membrane-electrode assembly for a polymer electrolyte membrane fuel cell, comprising a 7-layered membrane-electrode assembly being formed by attaching a sub-gasket having an opening therein to both surfaces of a 3-layered membrane-electrode assembly, the 3-layered membrane-electrode assembly comprising a polymer electrolyte membrane with catalyst electrode layers formed on the both surfaces thereof, wherein the catalyst electrode layers are exposed through the opening, and stacking a gas diffusion layer to cover the catalyst electrode layer exposed through the opening, wherein the gas diffusion layers is attached to the sub-gasket via a primer layer interposed therebetween.

6. The membrane-electrode assembly of claim 5, wherein a surface of an edge portion of the gas diffusion layer is attached to an edge portion surrounding the opening of the sub-gasket via the primer layer.
